(19) United States
(12) Patent Application Publication
(10) Pub. No.: US 2011/0057037 A1
(43) Pub. Date: Mar. 10, 2011

(54) PROCESS FOR TRANSFERRING PRODUCT INFORMATION UTILIZING BARCODE READER INTO PERMANENT MEMORY FOR AN IMPLANTED MEDICAL DEVICE

(75) Inventors: Christine A. Frysz, Orchard Park, NY (US); Robert A. Stevenson, Canyon Country, CA (US)

(73) Assignee: GREATBATCH LTD., Clarence, NY (US)

(21) Appl. No.: 12/752,348

(22) Filed: Apr. 1, 2010

Related U.S. Application Data
(63) Continuation-in-part of application No. 12/566,490, filed on Sep. 24, 2009.
Application No. 12/566,490 is a continuation-in-part of application No. 12/566,223, filed on Sep. 24, 2009.
(60) Provisional application No. 61/240,864, filed on Sep. 9, 2009.

(51) Int. Cl. G06K 19/07; G06F 17/00

(52) U.S. Cl. 235/385; 235/492; 235/375; 235/462.01

(57) ABSTRACT

A barcode having product information is paired with an implantable medical device or component. The barcode is optically read and at least a portion of the product information is stored into a temporary memory. At least a portion of the product information stored in the temporary memory is electronically written to permanent memory of an RFID chip associated with the implanted medical device or component.

### FIELD OF THE INVENTION

The present invention relates to a process for error-free transfer of product information to an RFID chip associated with an implantable medical device or component thereof. More particularly, the present invention involves pairing a barcode having product information with an implantable medical device or component, optically reading the barcode and storing at least a portion of the product information into a temporary memory, associating an RFID chip with the implantable medical device or component, and electronically writing at least a portion of the product information stored in a temporary memory, to permanent memory of the RFID chip.

### BACKGROUND OF THE INVENTION

The RFID reader industry has literally been exploding over the last few years with new applications and indications being discovered on what sometimes almost seems a daily basis. For example, RFID readers and their associated tags are being used for inventory tracking, pharmaceutical tracking, tracking of patients in hospitals, automated checkout in super markets of a basket full of goods with associated RFID tags, automobile keyless entry systems and keyless ignition systems, operating room sponge detector systems, and identification of patient RFID wrist bands. There are several main frequency bands that are now dominating the worldwide RFID industry. Four of the popular ones are low frequency (LF) which generally ranges from 125 to 150 kHz, high frequency (HF) which is at 13.56 MHz, very high frequency (VHF) which is at 433 MHz, and ultra high frequency (UHF) which generally operates at 915 MHz. Moreover, there are both national (American) and international (ISO) standards defining the modulation protocols and pulse widths and repetition rates so that standardized RFID tags can be read by a wide variety of readers. In fact, many readers transmit over a broad range of the RFID protocols for this exact reason. With the explosion of RFID emitters (readers, also known as interrogators, and sometimes referred to herein as communicators), patients with passive or active (electronic) medical devices (PMDs or AMDs) are increasingly running the risk of coming in close contact with such emitters. AMDs can also be implanted inside (or partially inside) the human body and are known as active implantable medical devices (AIMDs).

FIG. 1 is a wire formed diagram of a generic human body. Various locations are shown for active, passive, structural and other implantable and external medical devices 10 that are currently in use, and in which the present invention may find application. 10A represents a family of external and implantable hearing devices which can include the group of hearing aids, cochlear implants, piezoelectric sound bridge transducers and the like. 10B includes an entire variety of neurostimulators and brain stimulators, and hydrocephalic fluid pumps, drug and hormone insulin injection administration devices, etc. Neurostimulators are used, for example, to stimulate the Vagus nerve to treat epilepsy, obesity, Parkinsonism and depression. Brain stimulator systems are similar to a pacemaker-like pulse generator and include leads leading to electrodes implanted deep into the brain. One application involves sensing of the onset of abnormal SNS electrical activity and then providing electrical stimulation to brain tissue to abort the seizure. The electrodes on the end of the leads that arise from a deep brain stimulator are often positioned in the brain tissue using imaging, most commonly during real time MRI. 10C shows a cardiac pacemaker which is well-known in the art. 10D includes the various types of left ventricular assist devices (LVAD's), and artificial hearts, for example, the recently introduced centrifugal empowered devices. 10E includes an entire family of drug pumps which can be used for dispensing of insulin, chemotherapy drugs, pain medications and the like. Insulin pumps are evolving from passive devices to active or semi-active devices that have sensors and closed loop systems wherein real time monitoring of blood sugar levels is associated with directly related and programmable dose responses. These devices tend to be more sensitive to EMI than passive pumps that have no sense circuitry or transcutaneous leads. 10F includes a variety of external or implantable bone growth stimulators for rapid healing of fractures. 10G includes urinary and/or fecal incontinence devices. 10H includes the family of pain relief spinal cord stimulators and anti-tremor stimulators. 10H also includes an entire family of other types of neurostimulators used to block pain. 10I is representative of implantable cardioverter defibrillators (ICDs) including those with biventricular and multi-site synchronization capabilities for the treatment of congestive heart failure (CHF). 10J illustrates an externally worn device. This external pack could be an insulin or other drug pump, an external neurostimulator or pain suppression device, a Holter monitor with skin electrodes or even a ventricular assist device power pack. 10K illustrates the insertion of transcutaneous probe or catheter. These devices can be inserted into the femoral vein, for example, or into many other endovascular or endothelial lined cavities in the human body.

There are known in the art various methods for identifying implanted medical devices. One such method is the use of X-ray identification tags encapsulated within header blocks of pacemakers or implantable cardioverter defibrillators (ICDs). Such X-ray identification tags can be read on an X-ray of the implanted device and provide information to the physician. The information so provided is limited due to space and typically includes only the manufacturer and model number of the implanted device.

It would be beneficial if physicians were able to obtain additional information about an implanted device and/or a patient from an implanted identification tag. Such beneficial information includes, in addition to the manufacturer and model number of the device, the serial number of the device, the treating physician's name and contact information, and, if authorized by the patient (informed consent), the patient's name, contact information, medical condition and treatment, and other relevant information.

Currently, most active implantable medical device (AIMD) patients carry some sort of identification. This could be in the form of a card carried in the wallet or an ID bracelet indicating, for example, that they are a pacemaker wearer of a certain model and serial number. However, such forms of identification are often not reliable. It is quite common for an elderly patient to be presented at the emergency room (ER) of a hospital without his or her wallet and without wearing any type of a bracelet. In addition, there have been a number of situations where the patient (due to dementia or Alzheimer's, etc.) cannot clearly state that he or she even has a pacemaker.

Oftentimes the ER physician will palpitate the patient's chest and feel that there is an implanted device present. If the patient is comatose, has low blood pressure, or is in another form of cardiac distress, this presents a serious dilemma for the ER. At this moment in time, all that the ER knows is that the patient has some sort of an AIMD implant in his or her chest. It could be a pacemaker, a cardioverter defibrillator, or even a vagus nerve stimulator or deep brain stimulator.

What happens next is both laborious and time consuming. The ER physician will have various manufacturers' internal programmers transported from the hospital cardiology laboratory down to the ER. ER personnel will then try to interrogate the implanted medical device to see if they can determine what it is. For example, they might first try to use a Medtronic programmer to see if it is a Medtronic pacemaker. Then they might try a St. Jude, a Guidant, an ELA, a Biotronik or one of a number of other programmers that are present. If none of those programmers work, then the ER physician has to consider that it may be a neurostimulator and perhaps obtain a Cyberonics or Neuropace programmer.

It would be a great advantage and potentially lifesaving if the ER physician could very quickly identify the type of implant and model number. In certain cases, for example, with a pacemaker patient who is in cardiac distress, with an external programmer the ER could boost the pacemaker output voltage to properly recapture the heart, obtain a regular sinus rhythm and stabilize blood pressure. All of the lost time running around to find the right programmer, however, generally precludes this. Accordingly, there is a need for a way to rapidly identify the type and model number of an active implantable medical device so that the proper external programmer for it can be rapidly identified and obtained.

It is also important to note that implanted lead systems generally remain in the human body much longer than the active implantable medical device itself. For example, in the case of a cardiac pacemaker, the cardiac pacemaker batteries tend to last for 5 to 7 years. It is a very difficult surgical procedure to actually remove leads from the heart once they are implanted. This is because the distal TIP and other areas of the leads tend to become embedded and overgrown by tissue. It often takes very complex surgical procedures, including lasers or even open heart surgery, to remove such tissue encapsulated lead systems. When a pacemaker is replaced, the pectoral pocket is simply reopened and a new pacemaker is plugged into the existing leads. However, it is also quite common for leads to fail for various reasons. They could fail due to breakdown of electrical insulation or they could migrate to an improper position within the heart. In this case, the physician normally snips the leads off and abandons them and then installs new leads in parallel with the old abandoned leads.

Abandoned leads can be quite a problem during certain medical diagnostic procedures, such as MRI. Such leads can greatly overheat due to the powerful RF fields produced during MRI. Accordingly, it is important that there be a way of identifying abandoned leads and the lead type. Also, there is a need to identify such abandoned leads to an ER physician or other medical practitioner who may contemplate performing a medical diagnostic procedure on the patient such as MRI. This is in addition to the need to also identify the make and model number of the active implantable medical device.

It is also important to note that certain lead systems are evolving to be compatible with a specific type of medical diagnostic procedure. For example, MRI systems vary in static field strength from 0.5 Tesla all the way above 10 Tesla. A very popular MRI system, for example, operates at 3 Tesla and has an RF pulse frequency of 128 MHz. There are specific lead systems that are evolving in the marketplace that would be compatible with only this type of MRI system. In other words, it would be dangerous for a patient with a lead designed for 3 Tesla to be exposed to a 1.5 Tesla system. Thus, there is also a need to identify such lead systems to Emergency Room radiology and other medical personnel when necessary. For example, a patient that has a lead system that has been specifically designed for use with a 3 Telsa MRI system may have several pacemaker replacements over the years.

It is well known that RFID tag implants can be used for animals, for example, for pet tracking. They are also used in the livestock industry. For example, RFID tags can be placed on or in cattle to identify them and track certain information. An injectable RFID tag for humans has also been developed. However, none of the current RFID tags have been designed to have long term reliability, hermeticity, and biocompatibility within the body fluid environment.

The need for an RFID chip associated with a medical device such as an active implantable medical device is therefore well demonstrated. However, it is equally important that the RFID chip contain accurate information. It is the experience of the inventors that an operating room environment or even a surgical follow-up visit is not a good environment in general for data entry record keeping. There is a long history of medical errors, failure to enter a pacemaker model number, serial number, or lead types into patient records. Accordingly, a means is needed to accurately program and store certain key information onto an RFID tag that is associated with an AIMD. Prior art RFID readers/writers have keyboards which are often multi-function. If a physician or other medical practitioner were to enter highly detailed information such as a pacemaker model number, serial number, date of manufacture or the like, there would be a very significant chance for error. Even if the portable RFID reader/writer was interfaced with an external computer and a regular keyboard could be used, data entry errors would still occur at a significant rate.

Accordingly, a process is needed for error free transfer of product information to an RFID tag associated with an implantable medical device or component. The present invention fulfills this need and provides other related advantages.

### SUMMARY OF THE INVENTION

The present invention generally resides in a process for error-free transfer of product information to an RFID chip associated with an implantable medical device or component. The inventive process comprises the steps of (1) pairing a barcode having product information with an implantable medical device or component, (2) optically reading the barcode and storing at least a portion of the product information into a temporary memory, (3) associating an RFID chip with the implantable medical device or component, and (4) electronically writing at least a portion of the production information stored in the temporary memory to permanent memory of the RFID chip. In a preferred embodiment, the implantable medical device or component comprises an active implantable medical device. The RFID tag may include retrievable information relating to the implantable medical device and/or a patient.

The pairing step may include the step of pairing a unique barcode to a unique implantable medical device or component. The process further may include the steps of inputting additional data into the temporary memory, and electronically writing at least a portion of the additional data stored in the temporary memory to the permanent memory of the RFID chip.

The product information stored in the temporary memory which is electronically written to the permanent memory of the RFID chip may include information relating to manufacturer, model number, lot number, product serial number, manufacture date, manufacture location, product use instructions, product contra-indications, quality assurance data, product testing data, product sterilization data, packaging data, shipping data, and retailer data. The additional data input into the temporary memory may include patient data including personal data, patient drug regimes, pre-existing diseases and conditions, medical history, family medical history, address and contact information, additional information relating to the implantable medical device or component, information concerning related system implantable medical devices or components, information relating to associated leads and/or abandoned leads, implantable device and component compatibility, and expiration data.

The step of associating the RFID chip with the implantable medical device or component may include attaching the RFID chip to the implantable medical device or component, inserting the RFID chip into the implantable medical device or component, or affiliating the RFID chip with the implantable medical device or component. The affiliating step may include attaching the RFID chip to a secondary implantable medical device or component which is associated with the primary implantable medical device or component.

The implantable medical device or component may comprise a cochlear implant, a piezoelectric sound bridge transducer, a neurostimulator, a brain stimulator, a vagus nerve stimulator, a cardiac pacemaker, a left ventricular assist device, an artificial heart, a drug pump, a bone growth stimulator, a urinary incontinence device, a pain release spinal cord stimulator, an anti-tremor stimulator, an implantable cardioverter defibrillator, a congestive heart failure device, a cardio resynchronization therapy device, a lead, a catheter, an abandoned lead cap, or a suture sleeve.

The step of electronically writing at least a portion of the product information stored in the temporary memory to permanent memory of the RFID chip, may occur subsequent to implantation of the medical device or component into the patient. Moreover, the steps of inputting additional data into the temporary memory, and electronically writing at least a portion of the additional data stored in the temporary memory to the permanent memory of the RFID chip, may occur subsequent to the implantation of the medical device or component within the patient.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a wire-formed diagram of the generic human body showing a number of active and passive medical devices (AIMDs and PIMDs).

FIG. 2 is a perspective view of a prior art active implantable medical device (AIMD) having an RFID tag disposed within the header block.

FIG. 3 is an enlarged view of the RFID tag illustrated in FIG. 2.

FIG. 4 is a schematic illustration of a manufacturing system embodying the present invention.

FIG. 5 is a flow chart illustrating the process steps embodying the present invention.

FIG. 6 is a depiction of a patient with an AIMD fitted with an RFID tag communicating with an external interrogator/reader, embodying the present invention.

FIG. 7 is a perspective view of an exemplary sterile package used to hold an implantable device, having a tracking barcode associated therewith.

FIG. 8 is a perspective view of a hand held barcode RFID reader/writer unit, embodying aspects of the present invention.

FIG. 9 is a perspective view showing an RFID tag in a package attached through a clamping mechanism to an implanted lead of an AIMD.

FIG. 10 illustrates an abandoned lead cap with an internal RFID tag.

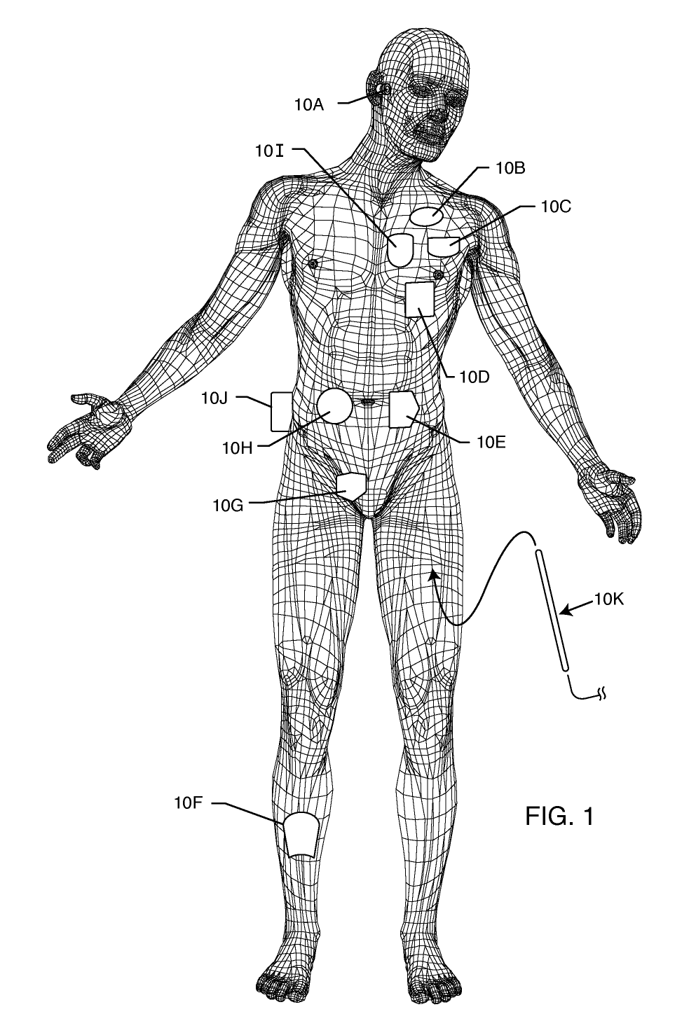

### DETAILED DESCRIPTION OF THE PREFERRED EMBODIMENTS

The present invention is direct to a novel process for error-free transfer of product information to an RFID tag associated with an implantable medical device or component, comprising the steps of: (1) pairing a printed barcode label having product information with an implantable medical device or component; (2) optically reading the barcode and storing at least a portion of the product information thereby read into a temporary memory; (3) associating an RFID tag with the implantable medical device or component; and (4) electronically writing at least a portion of the product information stored in the temporary memory to permanent memory of the RFID chip that is associated with the RFID tag.

The RFID tag of the present invention has an antenna and a microelectronic chip. The microelectronic chip is capable of storing information. This information is generally digitally stored and consists of both permanent and temporary memory locations. In a particularly preferred embodiment, the product information such as product model number, serial number and the like, would be stored into the RFID chip permanent memory. At or after the time of implantation, additional information could be added at the discretion of the doctor and/or with informed patient consent. This could include the patient's name, the physician's name, contact information or even important medical information.

In a particularly preferred embodiment, the process of reading a barcode label and then inputting that information error-free via electronic communication with an RFID tag, would be done as one of the later steps in the manufacturing operation of the implanted medical device.

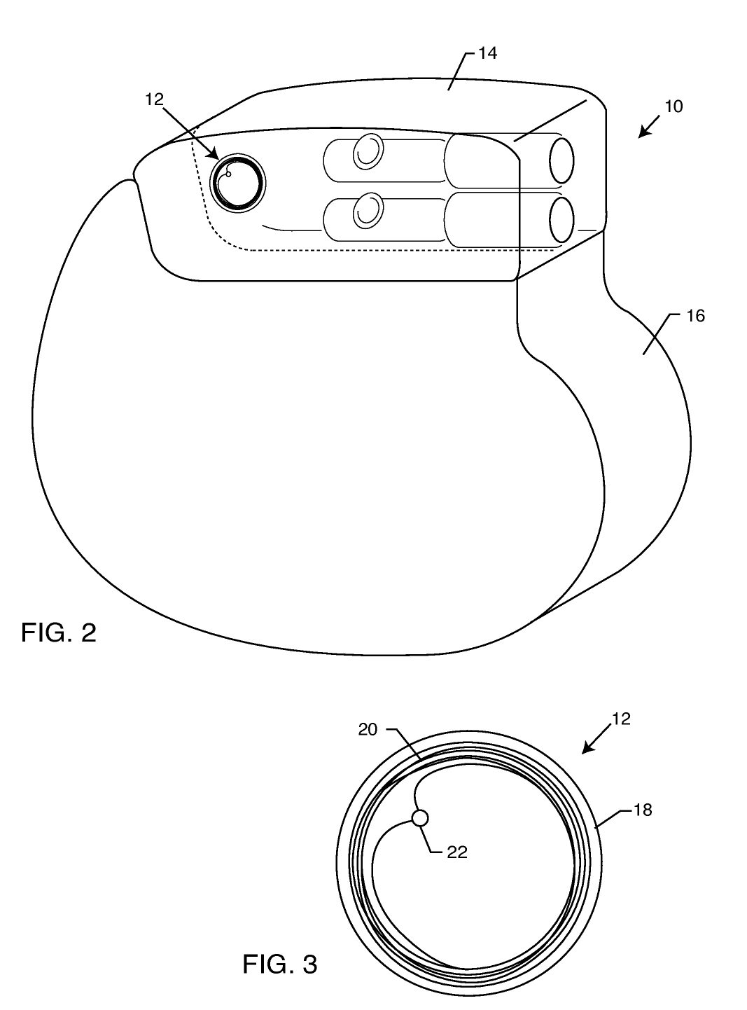

FIG. 2 illustrates a prior art active implantable medical device (AIMD) 10 such as a cardiac pacemaker. Shown is an RFID tag 12 disposed within the AIMD header block 14. In this case the header block 14 would be of a non-conductive plastic type material such as Techothane. The RFID tag 12 can be associated with the AIMD 10 in a number of ways. It could be disposed within the header block 14 as shown, or it could be placed within the AIMD housing 16, or it could be implanted at other locations within the human body such as the wrist.

FIG. 3 is an enlarged view of the RFID tag 12 shown in FIG. 2. The RFID tag 12 is disposed on a carrier or substrate 18. This carrier or substrate 18 is optional, but does facilitate easy handling of the RFID tag 12. The RFID tag 12 consists of an antenna assembly 20 and a microelectronic chip 22. Usually there is a capacitor wired in parallel with both the antenna 20 and the RFID chip 22. The purpose of the capacitor is to resonate with the antenna structure 20 forming a high Q circuit that can capture energy from an external reader. In a passive RFID tag application, it is the capture of this external energy that powers the RFID chip 22 and allows for a return pulse so that the data stored on tag 12 can be read. The RFID tag 12 illustrated in FIGS. 2 and 3 can be replaced by a number of geometries and possibilities. For example, the antenna 20 could be a solenoid antenna or a folded dipole antenna or many other shapes. In addition, the RFID chip 22 could be an active-type chip wherein it would derive power from another source such as the AIMD battery.

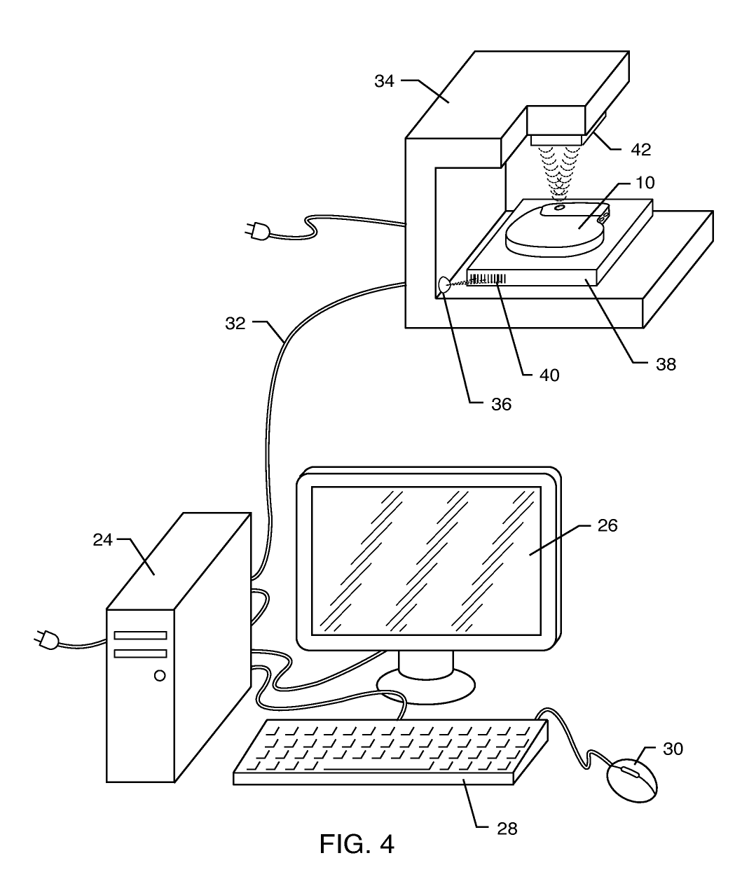

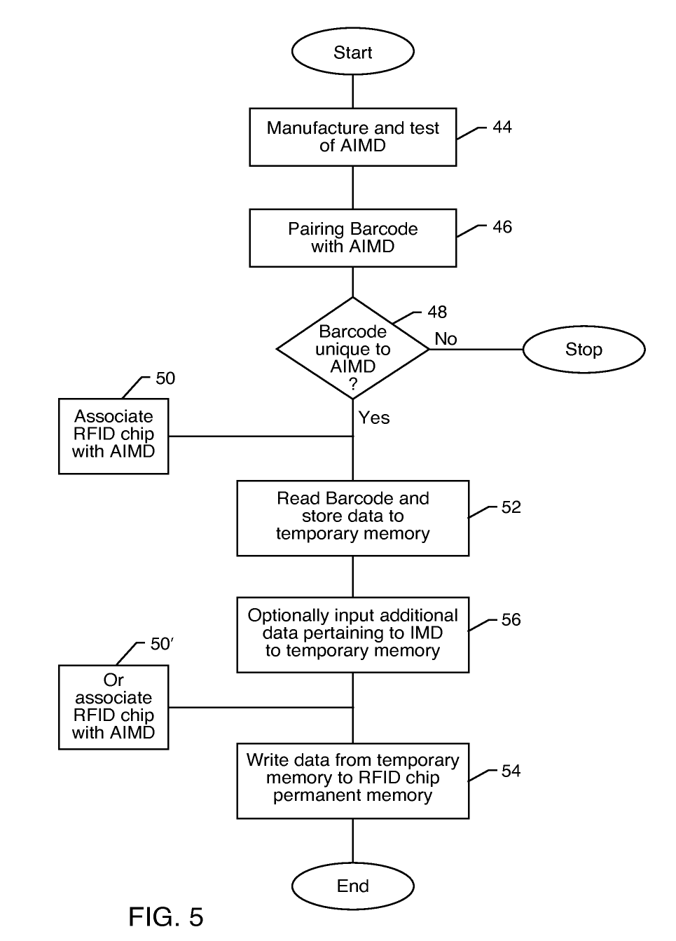

FIGS. 4 and 5 illustrate a manufacturing system and process of the present invention. Referring to FIG. 4, one can see a computer or central processing unit 24 which is generally connected to a monitor 26, a keyboard 28, and a mouse 30. There is a connecting wire 32 which interfaces this with a production line station 34. The production station 34 can be a bench top system consisting of an optical barcode reader 36 which is positioned to accept a production or sterile packaging box 38. The sterile packaging box 38 contains an implantable medical device (IMD) such as an active implantable medical device (AIMD) 10. The production lot traveler box or the packaging sterile box 38 has a barcode 40 as shown. The production station 34 also has an RFID writer 42 which can also act as a quality control interrogator (RFID reader/writer).

In a typical production line application, and with reference to FIG. 5, a kit is first started. In general the kit has the various parts required for assembling the IMD and is also associated with a lot traveler which may be paper or electronic including a barcode which usually contains important information including the lot number, starting date of manufacture, product model number and serial number. The next step is to manufacture and perform all the various tests that are associated with the IMD (44). The IMD in its finished form then can be paired with a barcode label (46) which can be one of several that were produced during the start (kitting) or produced (printed) at this time. A verification may be done to make sure that the barcode is unique to the (48). At this time the IMD can be associated with the particular RFID chip (50).

Referring once again to FIG. 4, the AIMD 10 and/or its unique packaging is placed in the manufacturing station 34. At this time the optical barcode reader 36 reads the barcode 40 on the box 38. The information read from the barcode 40 is electronically transferred to the memory of the computer system 24. See step 52 in FIG. 5. Predetermined data is selected such as the model number, serial number and date of manufacture, and then electronically conveyed from the computer 24 to station 34 where RFID write signals or pulse(s) are generated. This is to write the previously determined information to the RFID tag 12. There is also an optional verification step. That is, the RFID tag 12 will be interrogated by station 34 and a return pulse generated. This return pulse will be analyzed by the computer 24 to make sure that the information was properly stored on the tag 12 and that the information is correct. In general, the information that is stored to the tag 12 will be written into permanent memory (54) as indicated in FIG. 5. This is an area of the RFID tag 12 that cannot be changed, for example, by an implanting physician or by other hospital personnel. After the AIMD 10 is placed into its sterile packaging, shipped and subsequently implanted into a patient, then additional information can be added to the FRID tag 12 at or just before, during or after implantation (56). The primary purpose of the system and process illustrated in FIGS. 4 and 5 is to make sure that critical information is stored on the RFID tag 12 that is associated with the AIMD 10.

Referring once again to FIG. 4, one can see that this could be a wireless blue tooth or equivalent system without the need for all the associated wires and cables. It will also be apparent that the computer 24 could be part of a local area network (LAN) or a wide area network (WAN). In other words, the computer 24 could be part of an overall central computing system at a manufacturing site.

Referring once again to FIGS. 4 and 5, the critical information is optically read from the barcode 40 and stored into a temporary memory associated either with the RFID reader 42 or with a central processing computer 24. The barcode can be read at the lot traveler stage (pre-assigned); during any stage of AIMD manufacturing; during/after hermetic sealing of the AIMD; during/after electrical, mechanical or other testing of the AIMD; and during/after AIMD sterilization and/or packaging. That information is then electronically written to at least a portion of the memory of an RFID tag 12 and its associated microelectronic chip 22. The barcode 40 will be a unique barcode that is associated with a corresponding unique AIMD 10. The product information that is written to the RFID tag 12 comprises at least one of the manufacturer's name, the manufacturer's model number, the lot number, product serial number, date or dates of manufacture, manufacturing location, product use instructions, product contra indications, quality assurance data, product testing data, product serialization data, packaging data, shipping data, expiration data such as date of battery expiration, shelf-life and retailer data.

In general, the RFID tag 12 and its associated microelectronic chip 22 will have sufficient memory to add additional information later (56). This would be either just before, during or after date of implantation. For example, during implantation, particularly with informed patient consent, patient data including personal data, patient drug regimes, pre-existing diseases and conditions, medical history, family medical history, address and contact information of the patient and/or the physician, additional information relating to the implantable medical device or component, information concerning related system implantable medical device or components, information related to associated leads and/or abandoned leads, information related to the MR compatibility of the IMD, the AIMD or its associated leads, implantable device and component compatibility, and expiration data can all be added.

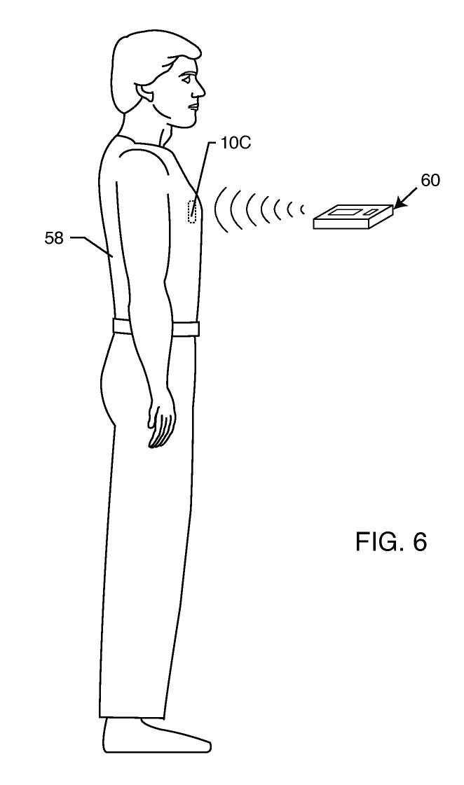

FIG. 6 illustrates a patient 58 who has had a pacemaker 1 OC implanted. Additional information is being added to the RFID chip 22 through an external RFID reader/writer 60.

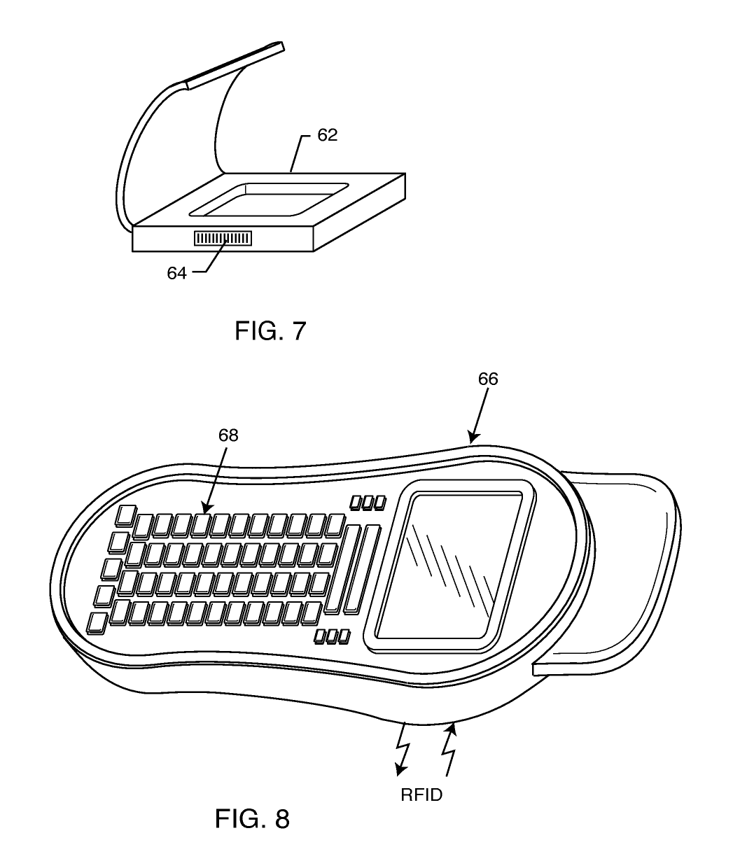

FIGS. 7 and 8 present an alternative to the manufacturing production line process described and illustrated in FIGS. 4 and 5. FIG. 7 illustrates a sterile packaging 62 that is typically used to house an IMD or an AIMD 10. It has a barcode label 64 that is associated with its packaging 62. FIG. 8 illustrates a combined hand-held barcode reader and RFID reader/writer 66 all in one unit. It has a keyboard 68. In this case the portable RFID reader/writer-barcode reader 66 can read the barcode 64 on package 62 and store this information temporarily into the reader's memory. It can then write this information to an RFID tag 12 associated with an IMD or an AIMD 10. The system shown in FIGS. 7 and 8 is extremely flexible as it can also be used for legacy products. Legacy products are defined as those that do not have an RFID tag associated with the IMD or AIMD at the time of manufacture. For example, an RFID tag 12 could be implanted within a patient's wrist or other area anywhere in his body. Then during AIMD implantation, the system of FIGS. 7 and 8 comes into play. That is, the RFID tag 12 associated with the patient's body can be accurately written by the novel process described herein. That is, the barcode 64 would be optically read by the hand-held reader 66 and then the RFID information would be electronically written to the tag 12. It should be pointed out that the RFID tag 12 need not be implanted. It could be associated for example with a patient RFID wrist band, bracelet, identity card and the like. The important thing is the process of writing error-free information to the RFID tag 12.

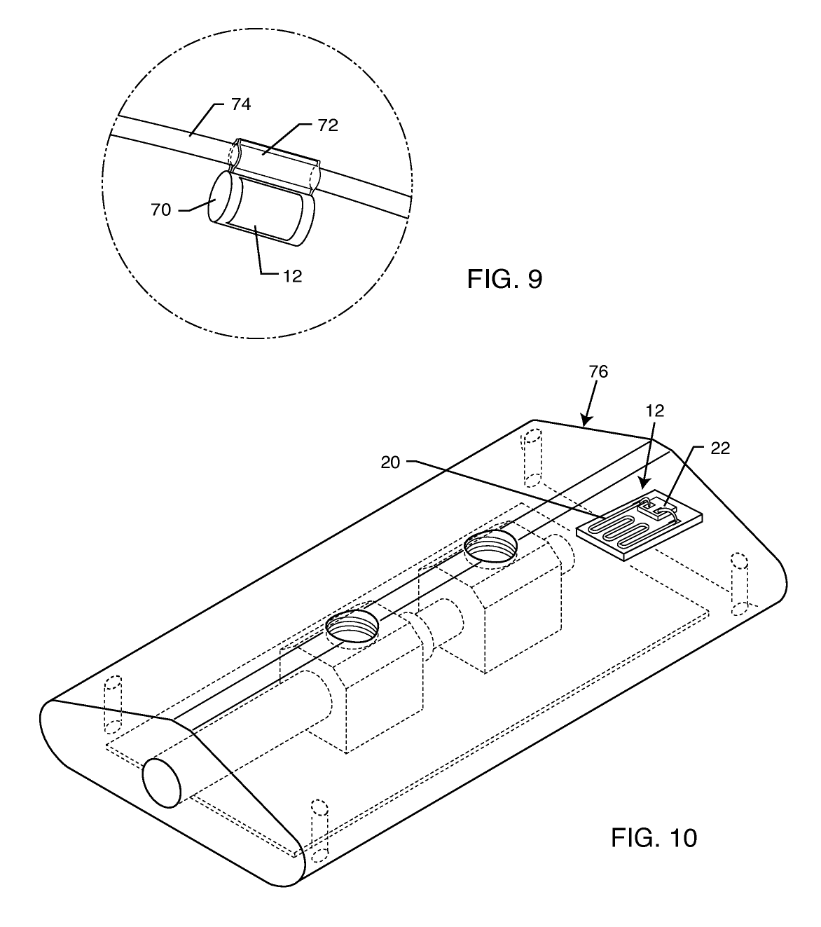

FIG. 9 illustrates a technique for adding an RFID tag 12 in a package 70 that is attached through a clamping mechanism 72 to an implanted lead 74 of an AIMD (not shown). It is very important to be able to identify implanted leads or other wires within the human body. This has to do with their compatibility with newer model AIMDs and also their MRI compatibility.

FIG. 10 illustrates one embodiment of an abandoned lead cap 76. Abandoned lead caps are described in U.S. patent application Ser. No. 12/693,836, the contents of which are incorporated here by reference. One can see that the abandoned lead cap 76 has associated an RFID tag 12 which includes an antenna structure 20 and an RFID microelectronic chip 22. As shown and described in U.S. patent application Ser. No. 12/693,836, there are a variety of sizes and shapes of abandoned lead caps that could be used. Leads are abandoned in the human body for a number of reasons. Leads can become obsolete and incompatible with newer model IMDs, leads can break, leads can dislodge or their insulation may fracture causing leakage currents. Often times leads are extracted, however they are often very difficult to dislodge as they become embedded in body tissues. Accordingly, many times they are simply snipped off, unplugged and just abandoned and left in the body. When a new AIMD is implanted there is usually enough room in the transvenous system to implant new leads in parallel with the old abandoned ones. It has been proven through numerous studies, however, that abandoned leads can be particularly problematic and dangerous during MRI scanning. This is because the energy that is induced in the implanted leads from the MRI RF pulsed field has nowhere to go. In other words, it cannot be redirected to the housing of the AIMD and dissipated.

From the foregoing it will be appreciated that the present invention provides a process for error-free transfer of product information to an RFID chip 12 associated with an implantable medical device (IMD) 10 or component thereof. The novel process of the present invention includes the steps of pairing a barcode having product information with an implantable medical device or component thereof, optically reading the barcode and storing at least a portion of the product information into a temporary memory, associating an RFID chip with the implantable medical device or component, and electronically writing at least a portion of the product information stored in the temporary memory to permanent memory of the RFID chip.

Although several embodiments have been described in detail for purposes of illustration, various modifications may be made without departing from the scope and spirit of the invention. Accordingly, the invention is not to be limited, except as by the appended claims.

What is claimed is:

1. A process for error-free transfer of product information to an RFID chip associated with an implantable medical device or component, comprising the steps of:
pairing a barcode having product information with an implantable medical device or component;
optically reading the barcode and storing at least a portion of the product information into a temporary memory;
associating an RFID chip with the implantable medical device or component; and
electronically writing at least a portion of the product information stored in the temporary memory to permanent memory of the RFID chip.

2. The process of claim 1, wherein the pairing step includes the step of pairing a unique barcode to a unique implantable medical device or component.

3. The process of claim 1, including the steps of inputting additional data into the temporary memory, and electronically writing at least a portion of the additional data stored in the temporary memory, to the permanent memory of the RFID chip.

4. The process of claim 1, wherein the product information comprises at least one of: manufacturer, model number, lot number, product serial number, manufacture date, manufacture location, product use instructions, product contra-indications, quality assurance data, product testing data, product sterilization data, packaging data, shipping data expiration data, shelf life, and retailer data.

5. The process of claim 3 or 4, wherein the additional data comprises at least one of: patient data including personal data, patient drug regimes, pre-existing diseases and conditions, medical history, family medical history, address and contact information, additional information relating to the implantable medical device or component, information concerning related system implantable medical device or components, information relating to associated leads and/or abandoned leads, implantable device and component compatibility, and expiration data.

6. The process of claim 1, wherein the associating step includes the step of attaching the RFID chip to the implantable medical device or component.

7. The process of claim 1, wherein the associating step includes the step of inserting the RFID chip into the implantable medical device or component.

8. The process of claim 1, wherein the associating step includes the step of affiliating the RFID chip with the implantable medical device or component.

9. The process system of claim 8, wherein the affiliating step includes the step of attaching the RFID chip to a secondary implantable medical device or component which is associated with the primary implantable medical device or component.

10. The process of claim 6, 7 or 8, wherein the implantable medical device or component comprises a cochlear implant, a piezo electric sound bridge transducer, a neurostimulator, a brain stimulator, a vagus nerve stimulator, a cardiac pacemaker, a left ventricular assist device, an artificial heart, a drug pump, a bone growth stimulator, a urinary incontinence device, a pain release spinal cord stimulator, an anti-tremor stimulator, an implantable cardioverter defibrillator, a congestive heart failure device, a cardio resynchronization therapy device, a lead, a catheter, an abandoned lead cap, or a suture sleeve.

11. The process of claim 1, wherein the step of electronically writing at least a portion of the product information stored in the temporary memory, to permanent memory of the RFID chip, occurs subsequent to implantation of the medical device or component into the patient.

12. The process of claim 3, wherein the steps of inputting additional data into the temporary memory, and electronically writing at least a portion of the additional data stored in the temporary memory, to the permanent memory of the RFID chip occurs subsequent to the implantation of the medical device or component within a patient.

13. The system of claim 1, wherein the RFID tag includes retrievable information relating to the implantable medical device and/or the patient.
